(19) United States
(12) Patent Application Publication
(10) Pub. No.: US 2009/0175686 A1
(43) Pub. Date: Jul. 9, 2009

(54) Fluid injection deflector shield viewing apparatus and method

(76) Inventor: Torsten Kruger, Oceanside, CA (US)

Correspondence Address: HARRY V. MCGAHEY JR., 1532 SIXTH AVENUE, SAN DIEGO, CA, 92101, US

(21) Appl. No.: 12/008,178

(22) Filed: Jan. 9, 2008

(51) Int. Cl. B63C 11/48; B63C 11/00; B01D 35/00

(52) U.S. Cl. 405/52; 137/544; 210/170.01

(57) ABSTRACT

A fluid injection deflector shield viewing apparatus with a deflector shield, a fluid concentrating focal area on one side of the deflector shield, an anchoring means to secure the deflector shield in the desired location, a fluidic material of decreased visibility, an observation means, a filtration system to filter the fluidic material, an intake to take in the fluidic material of decreased visibility, a discharge for introducing the filtered fluidic material into the fluid concentrating focal area on one side of the deflector shield, and a fluid transport means to transport the filtered fluidic material to the discharge. A preferred embodiment includes having a moving anchoring system so as to change the position of the deflector shield. A preferred embodiment includes a means for moving the anchoring system so as to change the position of the deflector shield comprised of a plurality of self propelled thrusters.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of underwater observation methods and apparatus and more specifically to fluid Injection Deflector Shield methods for open water.

Past methods devised to attempt to observe objects in turbid or fluidic environments of decreased visibility have been many. Diving bells, wrap-around encapsulating or totally encapsulating systems have been attempted. U.S. Pat. No. 5,678,091 (Daspit 1997) consisted of a turbid water displacement viewer for video and the like which required the device to seal off the surrounding water. U.S. Pat. No. 4,867,608 (Kinghorn 1989) described a method and apparatus for repairing submerged liners similar to a back yard swimming pool with an open top. U.S. Pat. No. 4,356,789 (Bains 1985) was an apparatus for use in a high velocity stream for high velocity excavating. U.S. Pat. Nos. 3,854,296 3,954,610 (Pogonowski et. al. 1974 and 1976) were a method and device for a subsurface work chamber type of diving bell. U.S. Pat. No. 3,879,953 (Clark 1975) was a claim for a device for underwater observation which had to be placed over, so as to cover, the object being viewed. U.S. Pat. No. 3,838,434 (Hughes et. al. 1974) disclosed an underwater camera housing which had to be pressed against an object. U.S. Pat. No. 3,565,516 (Thomas et. al. 1971) was an extended range underwater optics system using a vortex flow. U.S. Pat. No. 3,482,903 (Thomas et. al. 1969) disclosed a water column optics system using water flow directors requiring a viewing means. U.S. Pat. No. 3,344,614 (Byck 1967 showed an underwater diving bell chamber. U.S. Pat. No. 2,396,267 (Johnson 1946) disclosed a device for viewing underwater bodies using a clear water chamber. All of these systems required total or partial encapsulation in order to be effective. Such methods therefore tended to be inefficient for unknown or large spaces in which encapsulation was not economical or technically feasible. The present invention is helpful even if it improves visibility by a percentage. It does not need to be 100% effective to be useful.

### BRIEF SUMMARY OF THE INVENTION

The primary object of the invention is to provide a better way to visualize the area when in areas of decreased visibility.

Another object of the invention is to provide a more environmentally friendly method of observation in areas of decreased visibility because no change in the composition of the discharged fluid is required. Only the turbidity is being removed. No testing of the fluid or gas is required.

Another object of the invention is to provide more efficient rescue abilities in areas of decreased visibility.

A further object of the invention is to extend the serviceability of rescue personnel equipment because the fluid discharged in the apparatus has had the particulates removed.

Yet another object of the invention is to provide a safer environment for rescue personnel in areas of decreased visibility because the deflector shield will also partially shield rescue personnel from floating or flying debris in a portion of the area of decreased visibility.

Another object of the invention is an improved method of providing a more survivable area for persons or subjects of inspection in need of being rescued.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a Fluid Injection Deflector Shield comprising: a deflector shield, a fluid concentrating focal area on one side of the deflector shield, an anchoring means to secure the deflector shield in the desired location, a fluidic material of decreased visibility, an observation means, a filtration system means to filter the fluidic material, an intake means to take in the fluidic material of decreased visibility, a discharge means for introducing the filtered fluidic material into the fluid concentrating focal area on one side of the deflector shield, and a fluid transport means to transport the filtered fluidic material to the discharge means.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a cross sectional view of the invention.

FIG. 2a is a cross sectional view of a preferred embodiment of the invention using an external manifold.

FIG. 2b is a cross sectional view of a preferred embodiment of the invention using an internal manifold.

FIG. 3a is a cross sectional view of a preferred embodiment of the invention using an attached vane to the deflector shield itself.

FIG. 3b is a cross sectional view of a preferred embodiment of the invention using a venturi fluid directing means attached to the deflector shield itself.

FIG. 4a is a cross sectional view of a preferred embodiment of the invention using a fixed liquid ejection means oriented towards the horizontal axis of the deflector shield orientation.

FIG. 4b is a cross sectional view of a preferred embodiment of the invention using an adjustable liquid ejection means.

FIG. 5a is a cross sectional view of a preferred embodiment of the invention using a mesh liquid ejection means.

FIG. 5b is a cross sectional view of a preferred embodiment of the invention using a fixed liquid ejection means oriented towards a center focal point of the deflector shield.

FIG. 6a is a cross sectional view of a preferred embodiment of the invention using a surface buoy and a bottom anchoring means.

FIG. 6b is a cross sectional view of a preferred embodiment of the invention using a floating anchoring means.

FIG. 6c is a cross sectional view of a preferred embodiment of the invention using self propelled means.

FIG. 7a is a frontal plan view of a preferred embodiment of the invention wherein the deflector shield has movable vanes or orifices attached to it for steering.

FIG. 7b is a frontal plan view of the deflector shield in an oval configuration.

FIG. 8a is a frontal plan view of the deflector shield showing the preferred configuration for a typical spacing of internal manifolds on the interior of a circular deflector shield.

FIG. 8b is a frontal plan view of the deflector shield showing the preferred configuration for a typical spacing of internal manifolds on the interior of a square deflector shield.

### DETAILED DESCRIPTION OF THE PREFERRED EMBODIMENTS

Detailed descriptions of the preferred embodiment are provided herein. It is to be understood, however, that the present invention may be embodied in various forms. The fluidic material may be water, liquid fluid, or gas. Therefore, specific details disclosed herein are not to be interpreted as limiting, but rather as a basis for the claims and as a representative basis for teaching one skilled in the art to employ the present invention in virtually any appropriately detailed system, structure or manner.

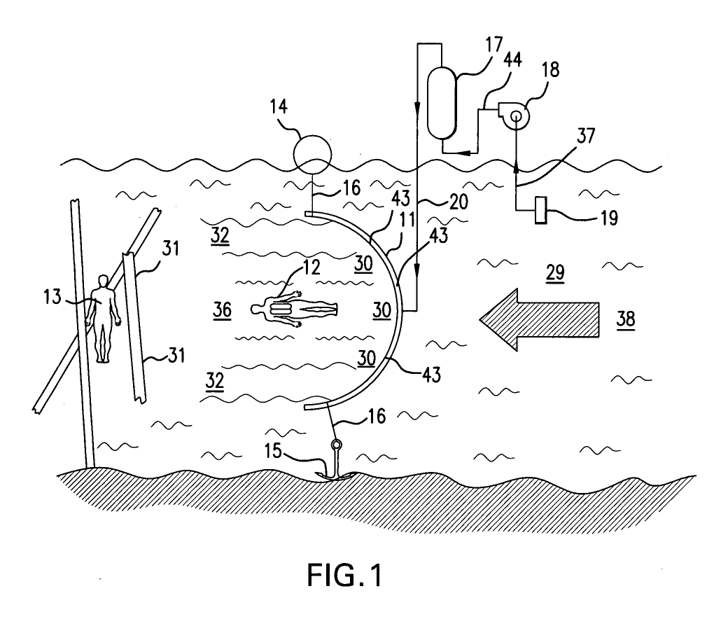

Turning first to FIG. 1 there is shown a cross sectional view of the invention comprising a fluid injection deflector shield 11 (“deflector shield”): a mixing zone—fluid concentrating focal area on one side of the deflector shield 32; an anchoring means to secure and support the deflector shield in the desired location from above 14 and below 15; a fluidic material of decreased visibility 29; an observation means 12; a filtration 15 system means 17 to filter the fluidic material; an intake means to take in the fluidic material of decreased visibility 19; a discharge means 43 for introducing the filtered fluidic material 30 into the fluid concentrating focal area on one side of the deflector shield; and a fluid transport means 20 to transport the filtered fluidic material to the discharge means 43. In the preferred embodiment shown in FIG. 1, the anchoring system is comprised of the fluid injection deflector shield 11 shown anchored by a tether 16 attached to an anchor 15 at the bottom, and a tether 16 connected at the top, to a buoyant means 14. The anchor means may be an anchoring system at the bottom of the fluid, an anchoring system at the top of the fluid, a sinking means relying on the weight of the device, a floating means increasing the buoyancy of the device, or a combination of these, or a plurality of these anchoring means and methods. The buoyant means may float on the surface of the fluid or it may float under the surface of the fluid. Murky water 29 is taken in through the inlet means 19 by a pump 18. A murky fluid transmission system means which in the preferred embodiment is comprised of a flexible hose 37 transmits the murky water from the inlet means 19 to a pumping means 18. A fluid transmission system means 44 then transmits the murky fluid to a filter 17. Although a flexible hose is used in the preferred embodiment for the fluid transmission systems 37 and 44, any type of fluid transmission whether stationary, movable, or flexible may be used. The filtered water after passing through the filter 17 is transmitted through a transmission means which in the preferred embodiment is a flexible hose 20, and then exits into the mixing zone 32 and the concentrating focal area of the mixing zone 36 on the concave side of the fluid injection deflector shield 11. The Observer 12 inside the clear fluid 30 and the concentrating mixing zone 36 is then better able to observe the inspection subject 13 in the debris 31 in the surrounding environment. The quality and quantity of the filtered fluid can be varied by the use of an adjusting means to vary these parameters. In FIG. 1 the direction of the current 38 is shown but the invention will work when the current is coming from any direction if there is a proper configuration, volume and speed of discharge of clear fluid through the plurality of discharge means 43.

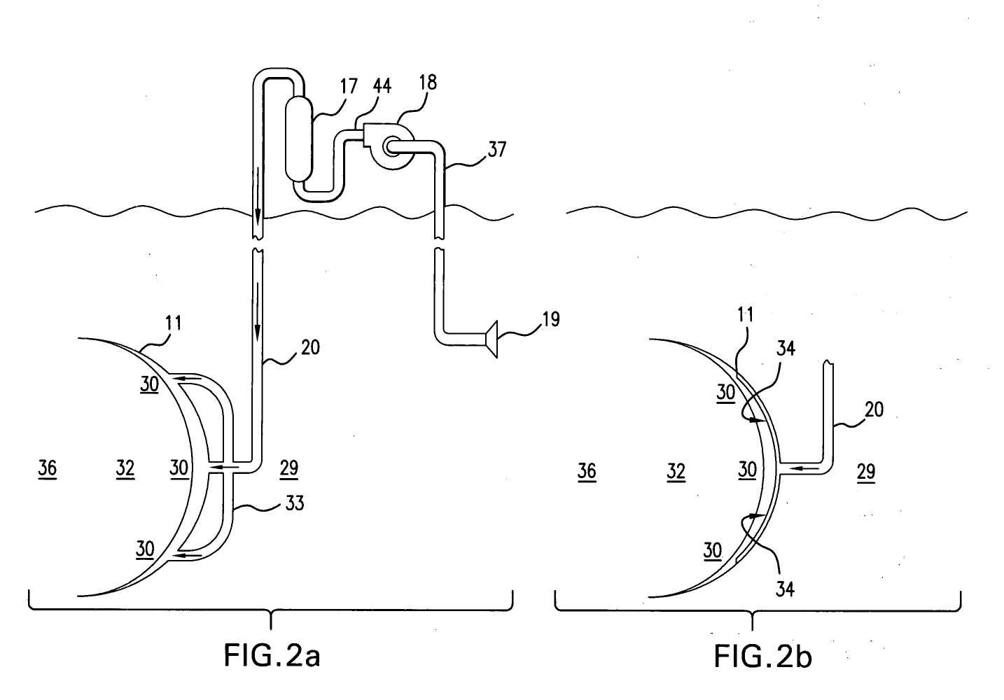

FIG. 2a is a cross sectional view of a preferred embodiment of the invention using an external manifold 33 as a discharge means to distribute the filtered water 30 into the mixing zone 32 and the concentrating focal area of the mixing zone 36. An observer in the mixing zone 32 is then able to see further into the murky water 29.

FIG. 2b is a cross sectional view of a preferred embodiment of the invention using an internal manifold 34 as a discharge means.

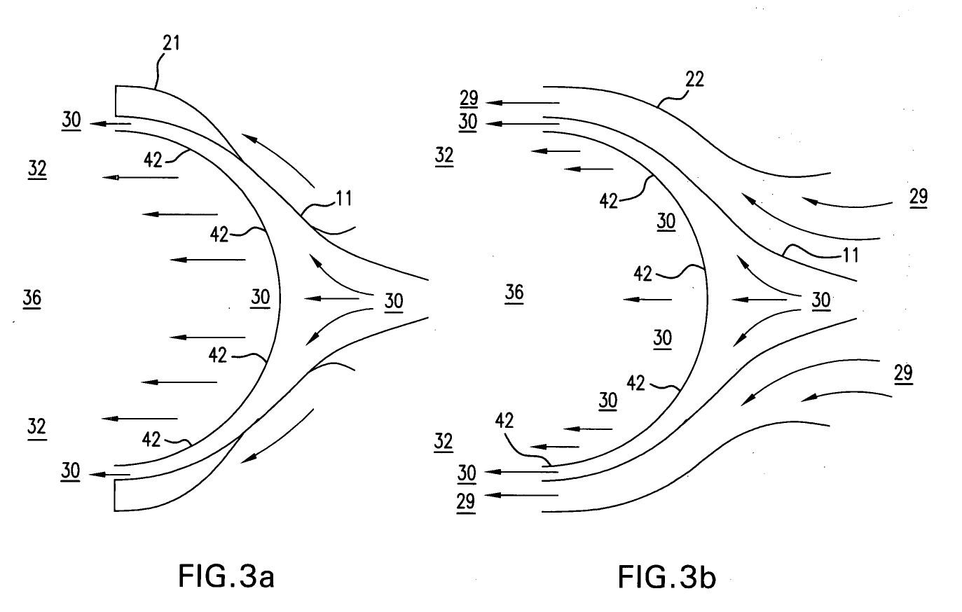

FIG. 3a is a cross sectional view of a preferred embodiment of the invention using a vane 21 attached to the deflector shield 11 itself for purposes of steering the injection deflector shield 11. Water ejected through a plurality of outlets 42 as a discharge means in the circumference of the fluid injection deflector shield 11 allow the vanes 21 to steer the device.

FIG. 3b is a cross sectional view of a preferred embodiment of the invention using a plurality of venturi fluid directing means 22 attached to the deflector shield 11 itself. The venturi are movable and allow the fluid to be directed in the desired direction. The system may be stationary or the various means described may be used to change the position of the deflector shield.

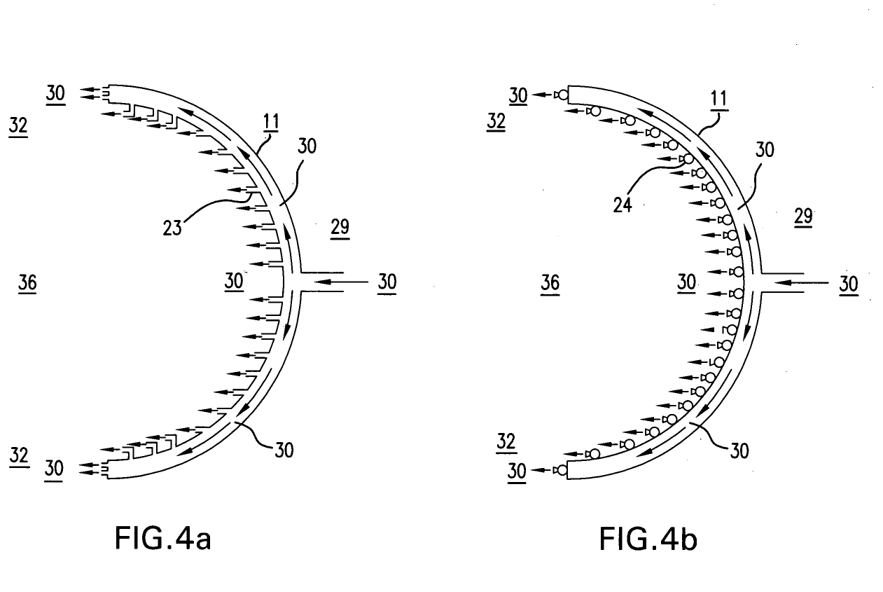

FIG. 4a is a cross sectional view of a preferred embodiment of the invention using a discharge means comprised of a plurality of fixed liquid ejection means 23 oriented towards the horizontal axis of the deflector shield orientation. Although the preferred embodiment shown uses fixed liquid ejection means, these liquid ejection means could also be adjustable as shown in FIG. 4b. Filtered fluid 30 enters at the fluid injection deflector shield 11 and is distributed through the interior of the deflector shield 11 emerging out through the plurality of fixed liquid ejection means 23. These liquid ejection means may be jets or nozzles of varying or variable configurations to allow the desired filtered water pattern to be disbursed into the deflector shield mixing zone—fluid concentrating area 36.

FIG. 4b is a cross sectional view of a preferred embodiment of the invention using a discharge means comprised of a plurality of adjustable liquid ejection means 24. Filtered fluid 30 enters at the fluid injection deflector shield 11 and is distributed through the interior of the deflector shield 11 emerging out through the plurality of adjustable liquid ejection means 24.

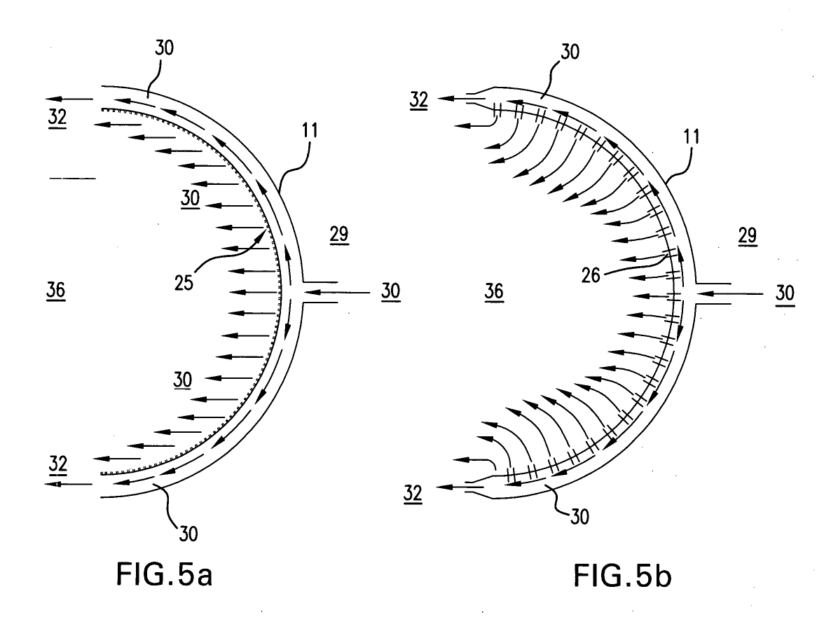

FIG. 5a is a cross sectional view of a preferred embodiment of the invention using a discharge means comprised of a mesh liquid ejection means 25.

FIG. 5b is a cross sectional view of a preferred embodiment of the invention using a discharge means comprised of a fixed liquid ejection means oriented towards a center or central focal point of the deflector shield 36. Filtered fluid 30 enters at the fluid injection deflector shield 11 and is distributed through the interior of the deflector shield 11 emerging out through a plurality of fixed liquid ejection means 26.

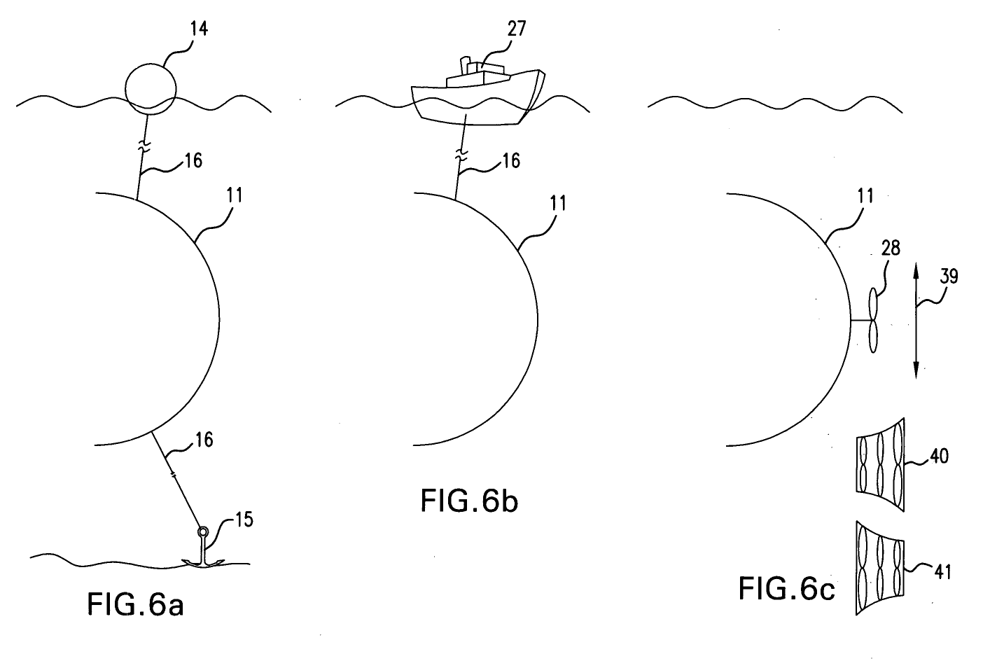

FIG. 6 illustrates three basic preferred embodiments for attachment and anchoring of the injection deflector shield 11 wherein it is supported using both buoyant systems and bottom anchoring systems to allow it to be supported and tethered in the desired location. Also sinking means comprised of weights may be attached or added to the fluid injection deflector shield so that it would be less likely to move or oscillate in a fast current when suspended by a tethering means. Also a self propelled embodiment using a propeller means 28 is shown. However the self propelled means could be any variation or combination of propeller, mechanical, thruster, venturi, jet or other self propelled means.

FIG. 6a is a cross sectional view of a preferred embodiment of the invention using a buoy 14 floating suspension means and a bottom anchor 15. Both the buoy 14 and the anchor 15 are connected to the fluid injection deflector 11 shield anchoring means by a plurality of tethers 16.

FIG. 6b is a cross sectional view of a preferred embodiment of the invention using a floating anchoring means. In this embodiment, the floating platform anchoring means 27 is a vessel on the surface of the water connected to the fluid injection deflector shield 11 by a plurality of tethers 16.

FIG. 6c is a cross sectional view of a preferred embodiment of the invention using a plurality of self propelled means 28 which has a neutral buoyancy that does not require any tethering. Multiple Thruster means 40 or Venturi means 41 also are shown.

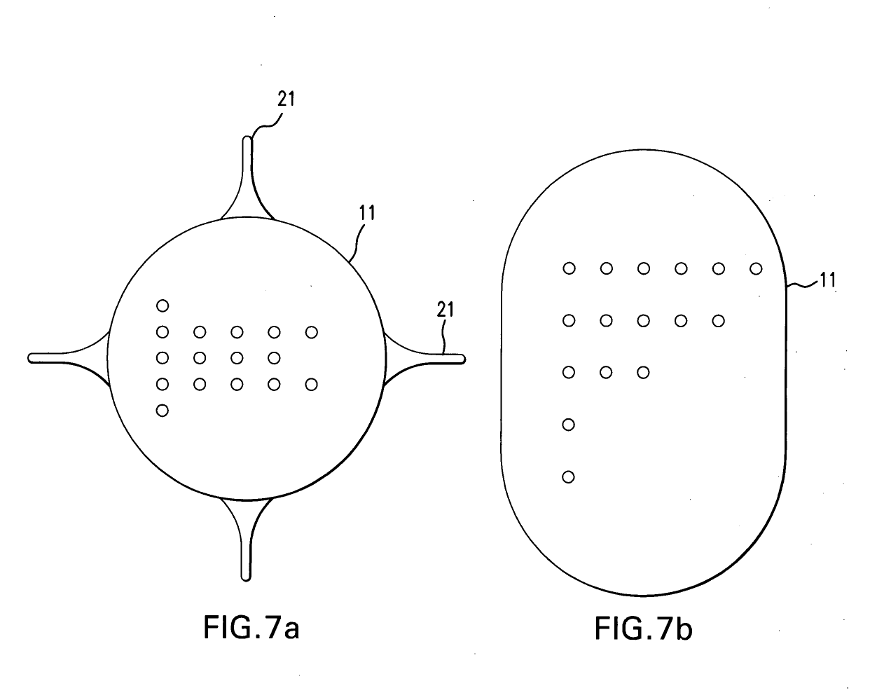

FIG. 7a is a frontal plan view of a preferred embodiment of the invention wherein the deflector shield 11 has movable steering vanes 21 attached to it for steering.

FIG. 7b is a frontal plan view of the deflector shield 11 in an oval configuration.

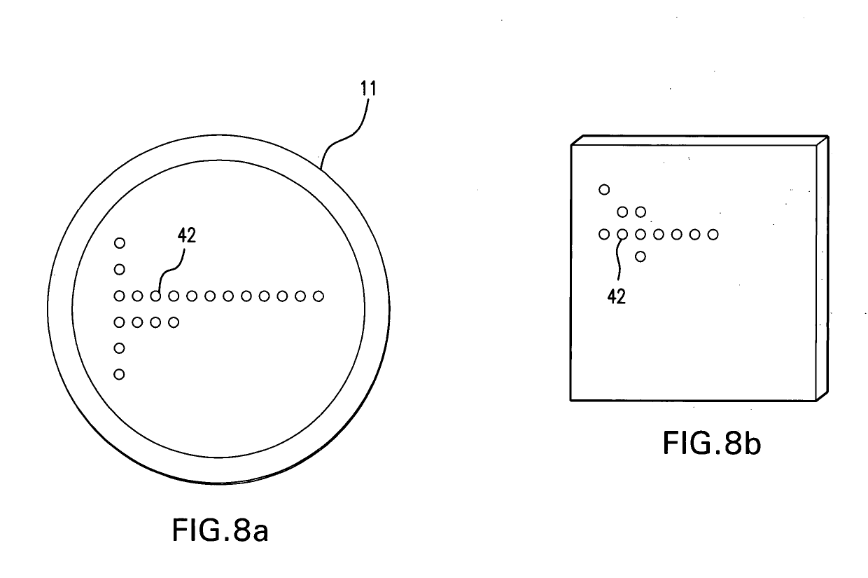

FIG. 8a is a frontal plan view of the deflector shield 11 showing the preferred configuration for a typical spacing of a plurality of internal manifold 42 exit points on the interior of a circular deflector shield.

FIG. 8b is a frontal plan view of the deflector shield 11 showing the preferred configuration for a typical spacing of a plurality of internal manifold exit points 42 on the interior of a square deflector shield. The shape of the deflector shield 11 may be any polygonal shape which achieves the desired mixing of filtered fluid and murky fluid to maximize visibility. The shape may also be of a flat or of a concave nature depending on the amount of current and the desired focusing of the concentrating focal area of the mixing zone 36 required.

While the invention has been described in connection with a number of preferred embodiments, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A fluid injection deflector shield viewing apparatus comprising:
a deflector shield;
a fluid concentrating focal area on one side of the deflector shield;
an anchoring means to secure the deflector shield in the desired location;
a fluidic material of decreased visibility;
an observation means;
a filtration system means to filter the fluidic material;
an intake means to take in the fluidic material of decreased visibility;
a discharge means for introducing the filtered fluidic material into the fluid concentrating focal area on one side of the deflector shield; and
a fluid transport means to transport the filtered fluidic material to the discharge means.

2. The fluid injection deflector shield viewing apparatus in claim 1 wherein the anchoring system is comprised of a plurality of buoyant, sinking and bottom anchoring means.

3. The fluid injection deflector shield viewing apparatus in claim 1 having a positioning means for moving the deflector shield so as to change its position.

4. The fluid injection deflector shield viewing apparatus in claim 3 wherein the positioning means for moving the anchoring system so as to change the position of the deflector shield is comprised of a plurality of adjustable vanes.

5. The fluid injection deflector shield viewing apparatus in claim 3 wherein the positioning means for changing the position of the deflector shield is comprised of a plurality of adjustable vanes anchored to the deflector shield.

6. The fluid injection deflector shield viewing apparatus in claim 5 wherein the means for changing the position of the deflector shield is comprised of a plurality of movable jets attached to the deflector shield itself.

7. The fluid injection deflector shield viewing apparatus in claim 1 wherein the positioning means for changing the position of the deflector shield is comprised of a plurality of self propelled means.

8. The fluid injection deflector shield viewing apparatus in claim 1 wherein the deflector shield is heavier than the surrounding fluid, lighter than the surrounding fluid, or of neutral buoyancy relative to the surrounding fluid.

9. The fluid injection deflector shield viewing apparatus in claim 1 wherein the deflector shield has adjustable buoyancy relative to the surrounding fluid.

10. The fluid injection deflector shield viewing apparatus in claim 1 wherein the discharge means for introducing the fluidic material into the fluid concentrating focal area on one side of the deflector shield has one point of attachment into the deflector shield.

11. The fluid injection deflector shield viewing apparatus in claim 1 wherein the discharge means for introducing the fluidic material into the fluid concentrating focal area on one side of the deflector shield has a plurality of points of attachment into the deflector shield.

12. The fluid injection deflector shield viewing apparatus in claim 1 wherein the discharge means for introducing the fluidic material into the fluid concentrating focal area on one side of the deflector shield is comprised of a plurality of venturi.

13. The fluid injection deflector shield viewing apparatus in claim 12 wherein the venturi are comprised of a plurality of nozzles, holes or ejector orifices.

14. The fluid injection deflector shield viewing apparatus in claim 12 wherein the venturi are adjustable.

15. The fluid injection deflector shield viewing apparatus in claim 12 wherein the venturi are movable.

16. The fluid injection deflector shield viewing apparatus in claim 1 wherein the discharge means for introducing the fluidic material into the fluid concentrating focal area on one side of the deflector shield is comprised of an external or internal manifold.

17. The fluid injection deflector shield viewing apparatus in claim 1 wherein the discharge means for introducing the fluidic material into the fluid concentrating focal area on one side of the deflector shield is comprised of a fixed liquid ejection means.

18. The fluid injection deflector shield viewing apparatus in claim 1 wherein the discharge means for introducing the fluidic material into the fluid concentrating focal area on one side of the deflector shield is comprised of an adjustable liquid ejection means.

19. The fluid injection deflector shield viewing apparatus in claim 1 wherein the discharge means for introducing the fluidic material into the fluid concentrating focal area on one side of the deflector shield is comprised of a mesh screen liquid ejection means.

20. The fluid injection deflector shield viewing apparatus in claim 1 wherein the deflector shield is in a circular, oval, square or polygonal configuration.
